(19) United States
(12) Patent Application Publication
(10) Pub. No.: US 2026/0072572 A1
(43) Pub. Date: Mar. 12, 2026

(54) ASYNCHRONOUS GENERATIVE AI TRANSFORMATION OF DIGITAL CONTENT IN RESPONSE TO A TRIGGER CONDITION

(71) Applicant: Microsoft Technology Licensing, LLC, Redmond, WA (US)

(72) Inventor: Sarah Ragab Ismail SALEH, Vancouver (CA)

(73) Assignee: Microsoft Technology Licensing, LLC, Redmond, WA (US)

(21) Appl. No.: 18/830,173

(22) Filed: Sep. 10, 2024

(51) Int. Cl. G06F 3/0484; G06Q 10/101

(52) U.S. Cl. CPC G06F 3/0484; G06Q 10/101

(57) ABSTRACT

A data processing system implements receiving, via an application services platform, a automatically monitoring changes to an interactive canvas of a digital content creation application being executed on a client device, wherein the digital content includes any of text, audio, video, or structured file, determining, based on the monitored changes, that a change to the interactive canvas corresponds to a trigger condition for a task, generating a prompt based on the trigger condition and the function in the task, transmitting the prompt to a largescale language generative model, generating a transformed digital content, and transmitting the transformed digital content to the client device to be displayed on a user interface of the client device.

### BACKGROUND

Modern life is busy and demanding with many different types of personal and work information. Artificial intelligence (AI) has been used to automate our lives to save time and increase productivity. While many AI systems automate various actions, the existing AI solutions often require manual prompting by humans, which while useful for many uses, is not always efficient in various situations. Furthermore, current AI systems lack mechanisms for customizing and initiating tasks related to digital content. Hence, there is a need for providing systems and methods of asynchronous generative AI transformation of digital content in response to a trigger condition for content consumption.

### SUMMARY

An example data processing system according to the disclosure includes a processor and a machine-readable medium storing executable instructions. The instructions when executed cause the processor alone or in combination with other processors to perform operations including automatically monitoring changes to an interactive canvas of a digital content creation application being executed on a client device; determining, based on the monitored changes, that a change to the interactive canvas corresponds to a trigger condition for a task, the task including the trigger condition and a function to be performed on a digital content appearing in the digital content creation application, wherein the digital content includes any of text, audio, video, or structured file; upon determining that the change corresponds to the trigger condition, automatically generating a prompt, via a prompt generator, based on the function to be performed on the digital content; transmitting the prompt and the digital content as an input to a largescale language generative model; generating, via the generative AI model, a transformed digital content that is modified in accordance with the function; and transmitting the transformed digital content to the client device to be presented on a user interface of the client device.

An example method implemented in a data processing system includes automatically monitoring changes to an interactive canvas of a digital content creation application being executed on a client device; determining, based on the monitored changes, that a change to the interactive canvas corresponds to a trigger condition for a task, the task including the trigger condition and a function to be performed on a digital content appearing in the digital content creation application, wherein the digital content includes any of text, audio, video, or structured file; upon determining that the change corresponds to the trigger condition, automatically generating a prompt, via a prompt generator, based on the function to be performed on the digital content; transmitting the prompt and the digital content as an input to a largescale language generative model; generating, via the generative AI model, a transformed digital content that is modified in accordance with the function; and transmitting the transformed digital content to the client device to be presented on a user interface of the client device.

An example non-transitory computer readable medium data processing system according to the disclosure on which are stored instructions that, when executed, cause a programmable device to perform functions of creating a task including a trigger condition and a function to be performed on a digital content appearing in a digital content creation application, wherein the digital content includes any of text, audio, video, or structured file; asynchronously monitoring to identify an existence of the trigger condition in the digital content on a client device; upon identifying the existence of the trigger condition in the digital content on the client device, automatically generating a prompt based on the function to be performed on the digital content; transforming the digital content by transmitting the prompt, a knowledge file and the digital content to a largescale language generative model, yielding a transformed digital content that is modified in accordance with the function; and transmitting the transformed digital content to the client device to be presented on a user interface of the client device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a diagram of an example computing environment in which the techniques for providing asynchronous generative AI transformation of digital content in response to a trigger condition are implemented.

FIG. 2 is a diagram of an example user interface of an asynchronous generative AI task system that implements techniques described herein.

FIG. 3 is a diagram of an example user interface of a portion of an interactive canvas of a digital content creation application that interacts with an asynchronous generative AI task system that implements techniques described herein.

FIGS. 4-6 are diagrams of example user interfaces of an AI-based content generation application in which the user is interacting with an AI generative model to add a task.

FIG. 7 and FIG. 8 are conceptual diagrams of an asynchronous generative AI transformation of digital content in response to a trigger condition of the system of FIG. 1 according to principles described herein.

FIG. 9 is a dataflow diagram of a workflow of a task creator of an asynchronous generative AI system of FIG. 1 according to principles described herein.

FIG. 10 shows an example of a dataflow diagram of a workflow of asynchronous generative AI transformation of digital content in response to a trigger condition of the system of FIG. 1 according to principles described herein.

FIG. 11 shows an example of a task data flow diagram of an asynchronous generative AI transformation system that operates in response to a trigger condition, according to principles described herein.

FIG. 12 is a flowchart of an example process for providing asynchronous generative AI transformation of digital content in response to a trigger condition according to the techniques disclosed herein.

FIG. 13 is a block diagram showing an example software architecture, various portions of which may be used in conjunction with various hardware architectures herein described, which may implement any of the described features.

FIG. 14 is a block diagram showing components of an example machine configured to read instructions from a machine-readable medium and perform any of the features described herein.

### DETAILED DESCRIPTION

Systems and methods for asynchronous generative AI task generation and/or transformation are provided that enhance productivity by leveraging triggers for task automation. The techniques herein provide an asynchronous generative AI task system that provides a technical solution to the technical problems associated with automating the generation, transformation and/or organization of digital content using a generative model. Current generative models struggle with task automation in view of changing conditions due to technical limitations in these models, such as but not limited to the model lacking an understanding of inherent data relationships, data ambiguity (multiple valid interpretations) and incompleteness, limited control and customization (that require a human touch for clarity and aesthetics), and the like. The asynchronous generative AI task system provided herein addresses these and other technical problems associated with current generative models by providing a framework for implementing tasks that automatically, asynchronously and conditionally prompt the generative model to perform specified actions in response to the occurrence of specified conditions. The asynchronous generative AI task system implements a two-phase solution including a task creation phase in which the tasks are created that cause the asynchronous generative AI task system to generate and/or transform content in specified ways in response to the occurrence of specified trigger conditions and an execution phase in which the asynchronous generative AI task system executes these tasks in response to the occurrence of the specified trigger conditions. The asynchronous generative AI task system acts as a virtual assistant that executes pre-set actions when certain conditions are met, transforming the workflow into a more efficient and intelligent process.

A task includes a function to be performed on digital content and transformation is the execution or performance of the task on the digital content by an AI tool such as a generative model (e.g., a large language model). For example, where the digital content is text content, a task could be “detect and expand any acronym” in the text content and the transformation could be the generation of the full wording of the acronym in the text content. When that task is triggered by detection of an acronym such as “a.p.i.”, the AI tool will generate the phrase “application program interface” and the phrase will be available to replace “a.p.i. ” in the text content or provided in a different format. Other examples of a task are “spot flaws in content”, “spot similar ideas”, “color based on content”and “validate and add references”.

The tasks include a trigger component, an action component and a format component, in some implementations. The trigger component defines one or more trigger conditions, which when satisfied, cause the asynchronous generative AI task system to execute the action. The action component instructs the asynchronous generative AI task system to generate specific content by constructing one or more prompts and submitting these prompts to one or more generative models to cause the models to perform the action by for example generating and/or transforming content. The action component can generate and/or transform content in various structured and/or unstructured file formats. The term “structured file” refers to a computer file that organizes data in a predefined format. This format typically follows a set of rules that determine how the data is arranged and accessed. Examples of structured files include but are not limited to CSV (Comma-Separated Values), Excel Spreadsheet (XLSX), database files, and the like. In contrast, unstructured files lack a predefined format. Examples of unstructured files include but are not limited to text documents, images, audio files, and videos. The format may be selected by a user or may be predefined. Once the digital content has been generated or transformed, the asynchronous generative AI task system then outputs the generated and/or transformed digital content for consumption.

The techniques herein can be used to implement a dynamic virtual assistant that significantly enhances workflow efficiency and intelligence in various types of applications by automatically and asynchronously executing predefined tasks when predefined conditions are met. The asynchronously executed predefined tasks unlock trigger-based scenarios, automate repetitive tasks and support better ideation sessions by spotting flaws and mistakes. To illustrate this concept with a non-limiting example, the asynchronous generative AI task system can be implemented to assist users in creating content in a notes application, an email application, slide presentation application, a collaboration platform, or other applications that enables users to create and/or modify digital content. The workflow of such applications can be enhanced by leveraging the ability of the asynchronous generative AI task system to automatically generate content in response to the occurrence of specified trigger conditions. In a non-limiting example, the virtual assistant can be tasked with fact checking content created in a digital whiteboard and/or examining the digital content created in the virtual whiteboard application for logical fallacies and performing specific actions in response to detecting such issues. A technical benefit of this approach is that the virtual assistant can leverage the asynchronous generative AI task system to improve the workflow in the application through conditional content generation and/or transformation by automatically generating and submitting prompts to a generative model or models in response to the occurrence of specified conditions. The asynchronous generative AI task system provides a technical improvement over current applications which do not provide for such automation of digital content generation.

In addition to the technical benefits of the asynchronous generative AI task system discussed above, the asynchronous generative AI task system provides numerous other technical benefits. One such benefit is that the techniques implemented by the asynchronous generative AI task system can consider contextual features when determining whether to generate and/or transform content. For example, the asynchronous generative AI task system can consider semantic context extracted from metadata, sensor data, and/or other such information to infer the user intent and to generate content that implements the user intent better than a system that does not take such contextual information into consideration. Another technical benefit of the asynchronous generative AI task system provided herein is that the asynchronous generative AI task system can iteratively refine the output generated by the generative model by revisiting and modifying the digital content generated by the generative language model until the final content meets the expected standards and accurately represents the intended information. Yet, another technical benefit of the asynchronous generative AI task system provided herein is that the asynchronous generative AI task system can extract content from a variety of sources and use this information to ground the generative models to ensure that the models generate accurate and relevant output. Yet, another technical benefit of asynchronous generative AI task system is providing user interfaces that allow users to interact with the system to edit the digital content, provide feedback, and re-generate the digital content based on the feedback. These and other technical benefits of the techniques disclosed herein will be evident from the discussion of the example implementations that follow.

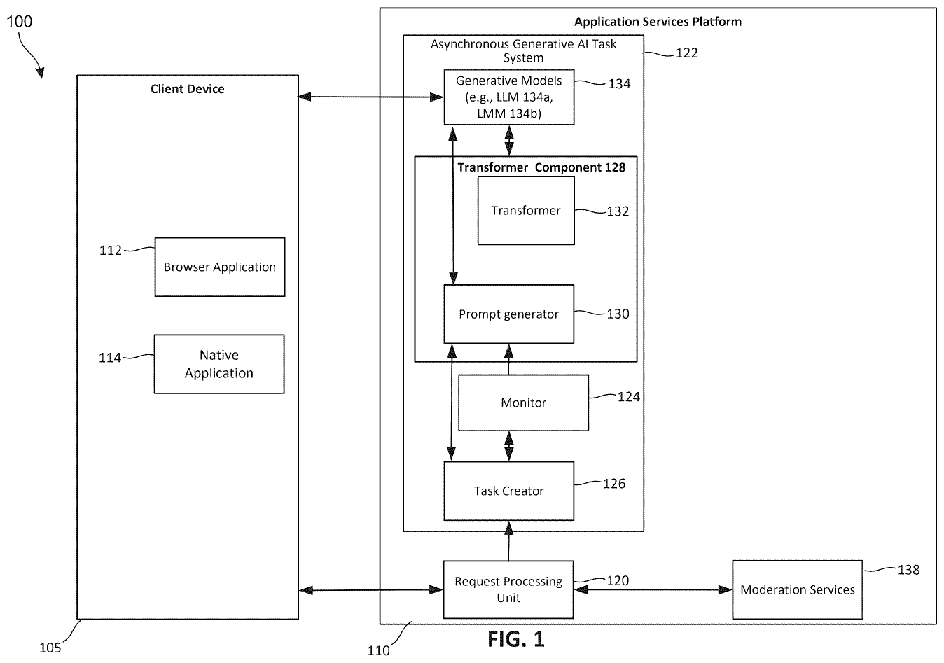

FIG. 1 is a diagram of an example computing environment 100 in which the techniques herein are implemented. The example computing environment 100 includes a client device 105 and an application services platform 110. The application services platform 110 provides one or more cloud-based applications and/or provides services to support one or more web-enabled native applications on the client device 105. These applications may include but are not limited to content generation applications, presentation applications, website authoring applications, collaboration platforms, communications platforms, and/or other types of applications in which users may create, view, and/or modify text and/or other content. In the implementation shown in FIG. 1, the application services platform 110 also applies generative AI to generate and/or transform content upon user demand, according to the techniques described herein. In one embodiment, the application services platform 110 is independently implemented on the client device 105. In another embodiment, the client device 105 and the application services platform 110 communicate with each other over a network (not shown) to implement the system. The network may be a combination of one or more public and/or private networks and may be implemented at least in part by the Internet.

The client device 105 is a computing device that may be implemented as a portable electronic device, such as a mobile phone, a tablet computer, a laptop computer, a portable digital assistant device, a portable game console, and/or other such devices in some implementations. The client device 105 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1 includes a single client device 105, other implementations may include a different number of client devices that utilize services provided by the application services platform 110.

As used herein, the term “digital content” refers to any information that exists in a format that can be processed by computers. Examples include text documents, images, audio files, videos, software applications, websites, social media posts, and the like. Although various embodiments are described with respect to digital content, it is contemplated that the approach described herein may be used with paper content or content embedded in other physical storage media than paper, which require pre-processing to convert into a digital format.

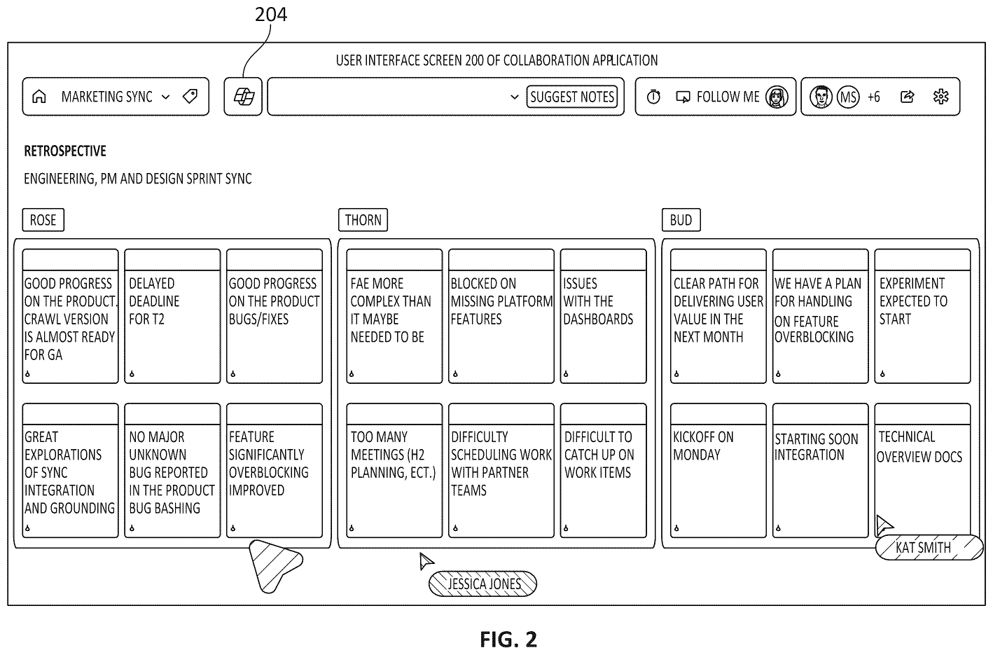

The client device 105 includes a browser application 112 and/or a native application 114. Both the browser application 112 and the native application 114 enable users to view, create, and/or modify digital content and obtain content data source(s), that is both web-based digital content, located on the client device or accessible by the client via a local area network. The application services platform 110 supports both the native application 114 and the one or more browser applications 112 in some implementations, and the users may choose which approach best suits their needs. One example of the browser applications 112 is WINDOWS® EDGE®, In some implementations. The native application 114 is a web-enabled native application, in some implementations, which enables users to view, create, and/or modify digital content. One example of the native application 114 is a program created in Visual Studio®. The browser applications 112 and the native application 114 implement a user interface shown in FIGS. 2-6 in some implementations.

Examples of the native application 114 include digital content creation applications, such as a note taking application, (e.g. Microsoft Notes®), a virtual meeting and collaboration application, a digital whiteboard application (e.g., Microsoft Whiteboard®), an employee experience application, an online collaboration application, a calendar application, an email application, a task management application, a team-work planning application, a software development application, an enterprise accounting and sales application, a social media application, or an online encyclopedia and/or database.

In some implementations, the browser application 112 and/or native application 114 is used for accessing, viewing and controlling the asynchronous generative AI task system 122 that performs asynchronous generative AI transformation of digital content in response to a trigger condition for content consumption provided by the application services platform 110. In some implementations, the application services platform 110 implements one or more web applications, such as the browser application 112, that enables users to view, create, and/or modify digital content and to obtain content data for creating and/or modifying digital content. The browser application 112 implements the user interfaces shown in FIGS. 2-6, in some implementations. The application services platform 110 supports both the native application 114 and the browser application 112 in some implementations, and the users may choose which approach best suits their needs.

The application services platform 110 includes a request processing unit 120 and an asynchronous generative AI task system 122. The asynchronous generative AI task system 122 includes a monitor 124, a task creator 126, a prompt generator 130, a transformer 132, and generative models 134. In some embodiments, the application services platform 110 also includes a moderation services 138.

The request processing unit 120 is configured to receive requests from the native application 114 and/or the browser application 112 of the client device 105. The requests can include requests to access the various services provided by the application services platform 110. For instance, the requests can include requests to access existing content, modify the existing content, and/or create new content. The request can also include requests to create and/or modify tasks that can be used by the asynchronous generative AI task system 122. As discussed above, the tasks activate monitoring of changes and events that dictate progression of the workflow and include a trigger component that defines one or more trigger conditions that cause the asynchronous generative AI task system 122 to execute the action component of the task and generate transformed digital content based on the task according to the function of the task. In some implementations, the task is received from a software application, and the software application is a virtual meeting and collaboration application, a digital whiteboard application, an employee experience application, an online collaboration application, a calendar application, an email application, a task management application, a team-work planning application, a software development application, an enterprise accounting and sales application, a social media application, or an online encyclopedia and/or database. The request processing unit 120 also coordinates communication and exchange of data among components of the application services platform 110 as discussed in the examples which follow.

The asynchronous generative AI task system 122 includes a task creator 126, a prompt generator 130, a transformer 132 and generative models 134. While the embodiment of the asynchronous generative AI task system 122 shown in FIG. 1 includes the one or more generative models 134, other implementations of the asynchronous generative AI task system 122 can access generative models that have been implemented on the application services platform 110 or by another computing platform that is accessible by the application services platform 110 via a network (not shown).

The task creator 126 receives a request to create a task from the native application 114 or the browser application 112. A task is an action to be performed on digital content. One example of digital content is textual content such as the content of a note or a message.

As discussed in the preceding examples, each task includes a trigger component and an action component. In some implementations, the native application 114 or the browser application 112 prompt the user to define each of these components and include this information in the request. The trigger component includes one or more trigger conditions to be satisfied. For example, where the task for the text content is “detect and expand any acronym” in the text content, the trigger condition is “any acronym” in the text content. In another example, where the task for the text content is “spot flaws in ideas in content”, the trigger condition is any “ideas” in the text content. In another example, where the task for the text content is “color based on content”, the trigger condition is any content in the text content. In another example, where the task for the text content is “validate and add references to fact”, the trigger condition is any fact in the text content.

Once the task is created, the trigger conditions are transmitted to the monitor 124 to detect the occurrence of one or more of the trigger conditions. In an example, the monitor 124 automatically monitors changes to an interactive canvas of a content creation application such as a notes application or a virtual whiteboard application and then determines if any detected changes correspond to one or more trigger conditions in an activated task. The monitor 124 may detect occurrence of trigger conditions by using AI, classifiers and/or content analysis tools. When the monitor 124 detects that a trigger condition has occurred in a type of digital content for which the task was generated, the monitor 124 transmits data about the detected trigger condition to the task creator 126, which then transmits a request to the transformation component 128 to initiate execution of the action component of the task. In some implementations, the monitor 124 itself transmits data about the detected trigger action and/or task to the transformation component 128.

The transformation component 128 instructs the asynchronous generative AI task system to perform or execute the task and generate specific content by utilizing the prompt generator 130 to construct one or more prompts related to the task and submitting these prompts to one or more generative models of the generative models 134 to cause the models to generate and/or transform content to perform the required action. The prompt generator 130 generates the prompt based on the trigger condition and the function in the task being representative of digital content, wherein the digital content includes any of text, audio, video, or structured file. For example, where the digital content is text content, and the task is a function to “detect and expand any acronym” in the text content, the prompt that is constructed and submitted to the one or more generative models of the generative models to cause the models to generate and/or transform content is “identify all acronyms in the text and expand them”. In another example, where the digital content is text content, and task is a function to “spot flaws in content”, the prompt that is constructed and submitted to the one or more generative models of the generative models 134 to cause the models to generate and/or transform content is “identify flaws in the content and flag each of the flaws”. In yet another example, where the digital content is text content, and task is a function to “spot similar ideas” in the text content, the prompt that is constructed and submitted to the one or more generative models of the generative models 134 to cause the models to generate and/or transform content is “identify all ideas in the text and identify the ideas that are similar to each other”. In yet example, where the digital content is text content, and task is a function to “color based on content”, the prompt that is constructed and submitted to the one or more generative models of the generative models 134 to cause the models to generate and/or transform content is “identify all different types of content in the text and add different font coloring to each of the different types of coloring”. As another example, where the digital content is text content, and task is a function to “validate and add references, the prompt that is constructed and submitted to the one or more generative models of the generative models 134 to cause the models to generate and/or transform content is “add references to text that has no references and validate all references in the text”. Thus, the prompt generator 130 generates the prompt based on the requested task, the actions needing to be performed and the type of model that is able to perform the action. The prompt generator 130 provides the prompt as an input to one or more generative models of the generative models 134.

The generative models 134 include one or more generative machine learning (ML) models trained to generate and/or modify textual and/or other types of digital content in response to natural language prompts. The digital content can include the various types of structured and/or structured content discussed herein. The natural language prompts may be input by a user via the native application 114 or via the browser application 112 or may be constructed by a prompt construction engine such as the prompt generator 130 In some implementations, the generative models include at least one large language model (LLM). Examples of such models include but are not limited to a Generative Pre-trained Transformer 3 (GPT-3), GPT-4, and/or a GPT-4o model. Other implementations may utilize other models or other generative models to generate and/or transform content in response to prompts. Furthermore, the models may be multimodal models that are capable of receiving and analyzing more than one type of input. As discussed above, the generative models 134 can include multiple models that are trained to generate various types of outputs.

In some implementations, the output of the generative models 134 is transmitted to the transformer component 128 for any required transformation before the output is provided for display. In an example, any additional transformation of the output is achieved by utilizing the transformer 132, which receives the output performs a transformative process to yield a modified version of the output. In an example, the transformation includes transmitting the digital content and prompt back to the client device 105, for example, for insertion as text on a diagram of a virtual whiteboard application.

In some implementations, the application services platform 110 also include the moderation service 138, which can be implemented by an ML model trained to analyze the digital content of these various inputs and/or outputs to perform a semantic analysis on the digital content to predict whether the digital content includes potentially objectionable or offensive content. For example, the moderation service 138 can perform a check on the digital content using an ML model configured to analyze the words and/or phrases used in content to identify potentially offensive language/image/sound. The moderation service 138 can compare the language used in the digital content with a list of prohibited terms/images/sounds including known offensive words and/or phrases, images, sounds, and the like. The moderation service 138 can provide a dynamic list that can be quickly updated by administrators to add additional prohibited terms/images/sounds. The dynamic list may be updated to address problems such as words or phrases becoming offensive that were not previously deemed to be offensive. The specific checks performed by the moderation service 138 may vary from implementation to implementation. If one or more of these checks determines that the textual content includes offensive content, the moderation service 138 can notify the application services platform 110 that some action should be taken.

The application services platform 110 complies with privacy guidelines and regulations that apply to the usage of user data included in the digital content to be semantically analyzed to ensure that users have control over how the application services platform 110 utilizes their data. The user is provided with an opportunity to opt into the application services platform 110 to allow the application services platform 110 to access the user data and enable the generative models 134 to generate and/or transform digital content according to user consent.

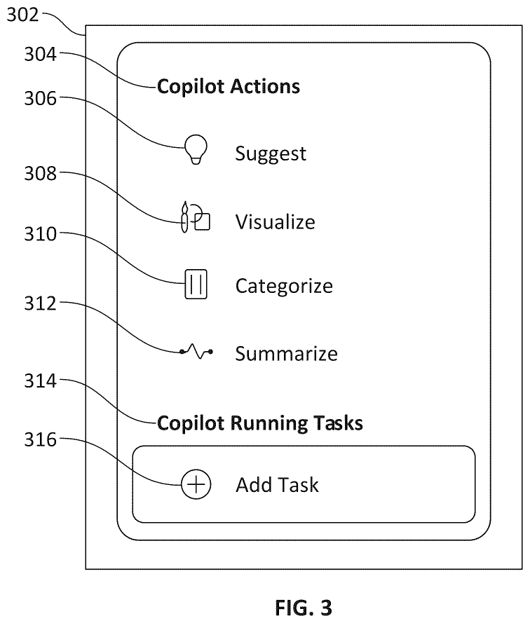

FIG. 2 is a diagram of an example user interface screen of a collaboration application that interacts with an asynchronous generative AI task system that implements techniques described herein. In an example, the collaboration application is a virtual whiteboard application that enables multiple users to collaborate and/or ideate with each other. As part of the collaboration, one or more of the users can add tasks for automating performance of certain actions in the interactive canvas of the collaboration application. For example, when one or more of the collaborators determine that the content of the whiteboard require organization, clarification, they may select a user interface element such as the virtual assistant icon 204 of UI screen 200 to add a task to the canvas. In some implementations, once selected, a control pane for an AI-based content generation application (such as but not limited to Microsoft Copilot®) such as the control pane 302 of FIG. 3. is displayed.

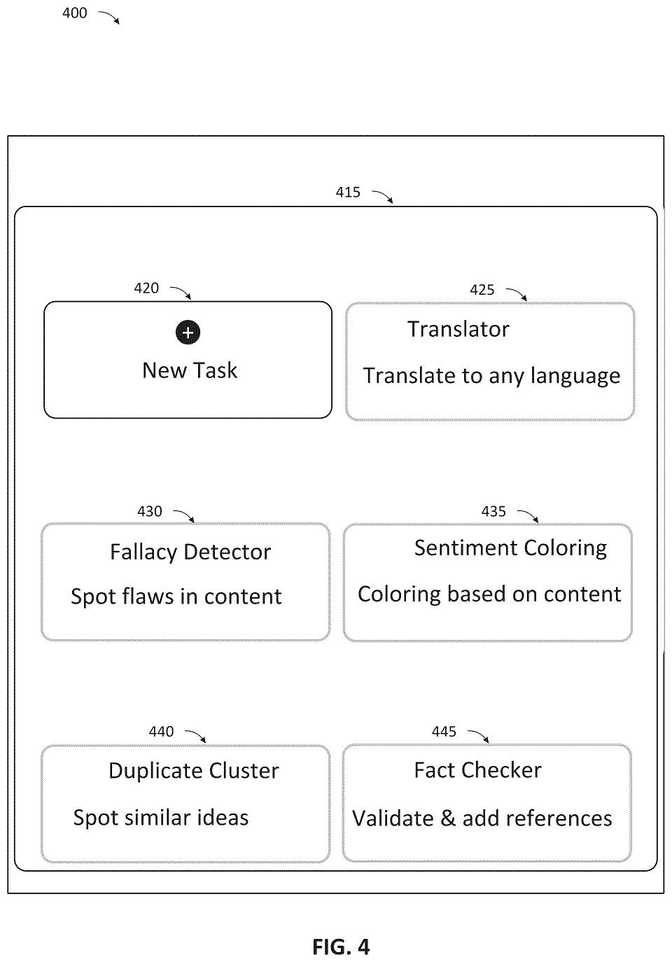

FIG. 3 is a diagram of user interface elements displayed when a user invokes a virtual assistant such as a copilot. The user interface elements include the control pane 302 which depicts a number of available virtual assistant actions 304 that can be performed by the virtual assistant. The actions 304 shown in the control pane 302 include a “Suggest” action 306, a “Visualize” action 308, a “Categorize” action 310, and a “Summarize” action 312. The control pane 302 also includes a list of “Running Tasks” 314 which when selected may display a list of tasks that have previously been added for the canvas. The control pane 302 also includes a button 316 to add a task which when selected invokes the task creator 126 in FIG. 1. In some implementations, when the button 316 is selected a user interface element such as the user interface elements of FIG. 4, 5 or 6 is displayed.

FIGS. 4, 5, and 6 are diagrams of an example user interface of an asynchronous generative AI task system that implements the techniques described herein. The example user interface shown in FIGS. 4, 5, and 6 are user interfaces of an asynchronous generative AI task system that uses an AI-based content generation application, such as but not limited to Microsoft Copilot®. However, the techniques herein for providing asynchronous generative AI transformation of digital content in response to a trigger condition are not limited to use in the AI-based content generation application and may be used to transform content for a variety of types of applications including but not limited to notes application, an email application, slide presentation application, a collaboration platform, and/or other types of applications in which users create, view, and/or modify various types of digital content. Such applications can be a stand-alone application, or a plug-in of any application on a client device. For example, the system can work on the web or within a virtual meeting and collaboration application (e.g., MICROSOFT TEAMS®) or an email application (e.g., OUTLOOK®). The system can be integrated into the MICROSOFT VIVA® platform or could work within a browser (e.g., WINDOWS® EDGE®), or MICROSOFT COPILOT®. The system can also work within a website chat functionality (e.g., the BING® chat functionality).

FIG. 4 shows an example of the user interface 400 of an AI-based content generation application (e.g., virtual assistant) in which the user is interacting with an AI generative model to add a task. The user interface 400 includes a control pane 415. The user interface 400 may be implemented by the native application 114 and/or the browser application 112 in FIG. 1.

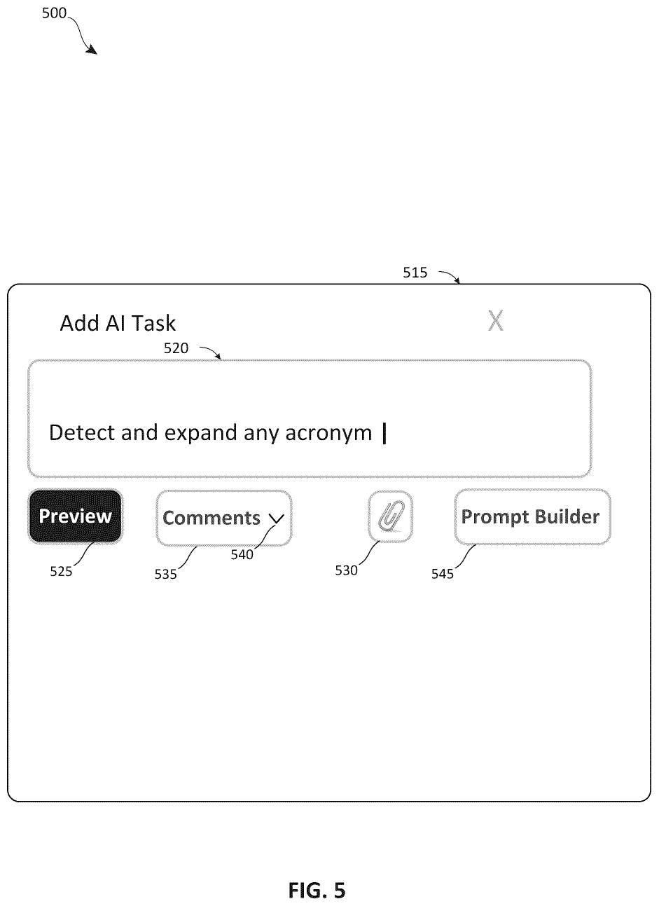

The control pane 415 includes a new task button 420, a translator button 425, fallacy detector button 430, a sentiment coloring botton 455, duplicate cluster button 440, and fact checker button 445. The selection of the new task button 420 initiates the creation of a new task which may involve generating a customized task. In some implementations, selection of the new task button 420 results in the display of the user interface 500 of FIG. 5, as discussed in further details below.

The button 425 enables the user to add a “translator” task to the canvas. The translator task may be selected from a library of tasks for text content. The action for the translator task will be to “translate a language” in the text content and the transformation could be the translation of the text content into another language. The button 430 allows a “Fallacy Detector” task to be selected from the library of tasks, where the task will be a function to “spot flaws in content” of the text content and the transformation could be the identification and/or flagging of flaws in the content. The button 435 allows a “Sentiment Coloring” task to be selected from the library of tasks, where the task will be a function to “coloring based on content” and the transformation could be the visual coloring of the text in accordance with sentiment. The button 440 allows a “Duplicate Cluster” task to be selected from the library of where the task will be a function to “spot similar ideas” in the text content and the transformation could be the identification and/or flagging of the text content of similar ideas. The button 445 allows a “Fact Checker” task to be selected from the library of tasks where the task will be a function to “Validate and add references” in the text content and the transformation could be adding references to validated assertions of the text content. It should be noted that FIG. 4 displays a few examples of tasks from a library of available task. Other types of tasks may be available for different types of applications and/or different configurations.

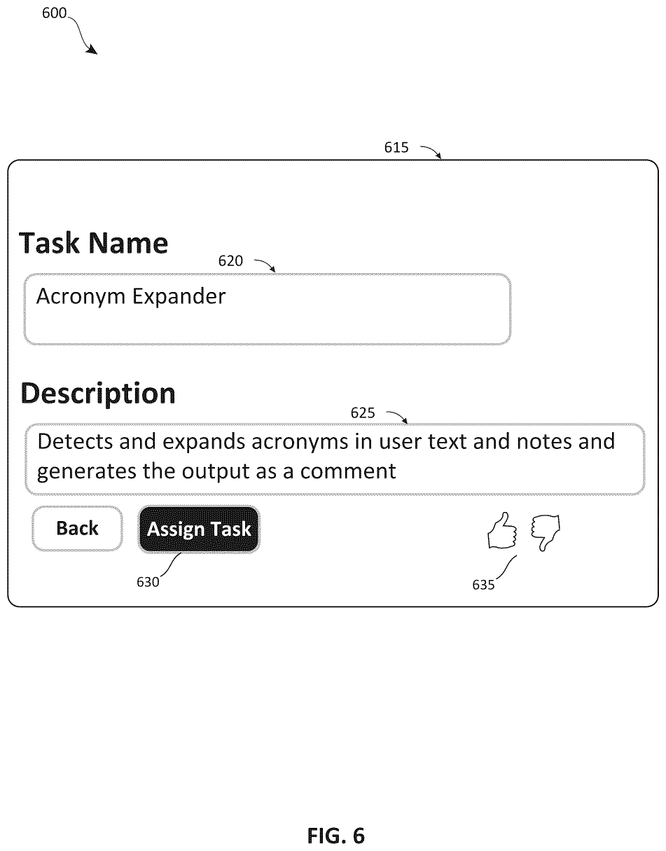

FIG. 5 shows an example of the user interface 500 of a task creator of an AI-based content generation application in which the user can create a customized task for interacting with an AI generative model to transform content in response to a trigger condition. The user interface 500 may be implemented by the native application 114 and/or the browser application 112 in FIG. 1. The user interface 500 includes a control pane 515. The control pane 515 will be displayed when new task 420 is selected in control pane 415 in user interface 400 of FIG. 4. A task, that includes a trigger condition and a function to be performed on digital content, can be entered in the text field 520. For example, the trigger “any acronym” and function “expand” can be expressed as “detect and expand any acronym” and can be entered into text field 520 in a natural language text. In some implementations, a document can be attached to the task by utilizing the button 530. The document may be a file or other type of content for which the task should be performed or may provide additional information for performing the task. The user can utilize the button 535 to select the format or type of output desired for the task. For example, the user can select comments to indicate that the expanded acronym should be provided in a comment. Other formats for the output such as a note, directly inserting the output in the document and the like may be selected by utilizing the drop-down button 540. In some implementations, when the “preview” button 525 is clicked, the user interface in FIG. 6 is displayed. In other implementations, the user can select the prompt builder 545 to directly advance to generating a prompt for the task.

FIG. 6 shows an example of the user interface 600 of a task creator of an AI-based content generation application in which the user can assign a task for interacting with an AI generative model to transform content in response to a trigger condition. The user interface 600 may be implemented by the native application 114 and/or the browser application 112 in FIG. 1. The user interface 600 includes a control pane 615. The control pane 615 may be displayed when the user selects to preview a task for which they have entered information or when the user selects to enter additional information for a task they are generating. The control pane 615 enables the user to enter a task name for the task in text field 620 of control pane 615. A task description of the task can be entered in the task description field 625. In some implementations, the description is purely descriptive and is not interpreted as the function and trigger of the task. In other implementations, the description provides additional information related to the task. In an example, the description enables the user to select the format of the output they desire for the task. For example, the user can specify that the output should be generated as a comment that is inserted in the document. In other examples, the user may select the format as a new note or may select that the change be made directly in the content (e.g., replace the acronym within the content). In this manner, the user can define the type of trigger condition, the desired transformation as well as the desired output for the transformation. When the “assign task” button 630 is selected, the task 520, task name 620 and the task description 625 are saved as a new task. In some implementations, saved tasks are stored in a task library and can be later displayed as available tasks in other canvases and/or other applications. In some implementations, the user can utilize the UI elements 635 to provide feedback regarding automatically generated task name or task description.

In some implementations, the task name and task description are pre-filled, and the user is able to modify the text if desired. In such cases, AI tools may be used to automatically generate a task name and/or task description for the entered task. The automatically generated text enables the user to quickly and efficiently add the task for future use.

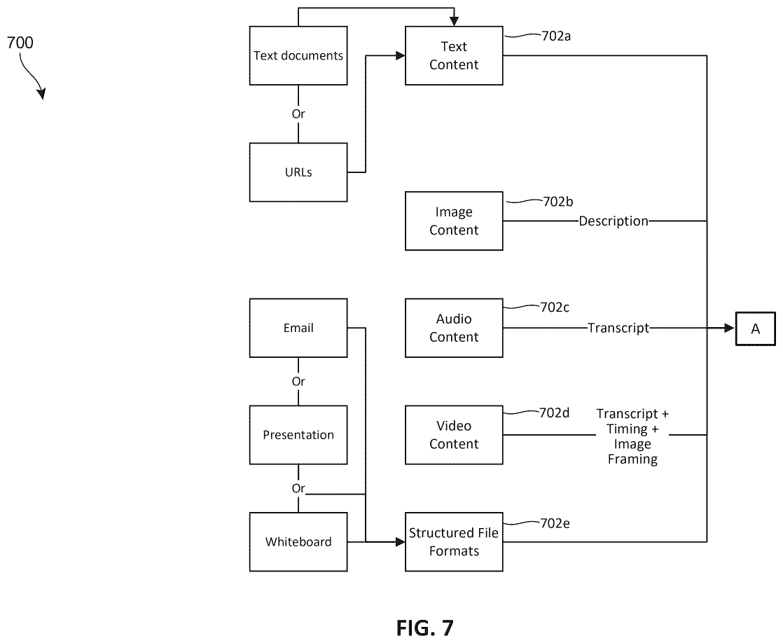

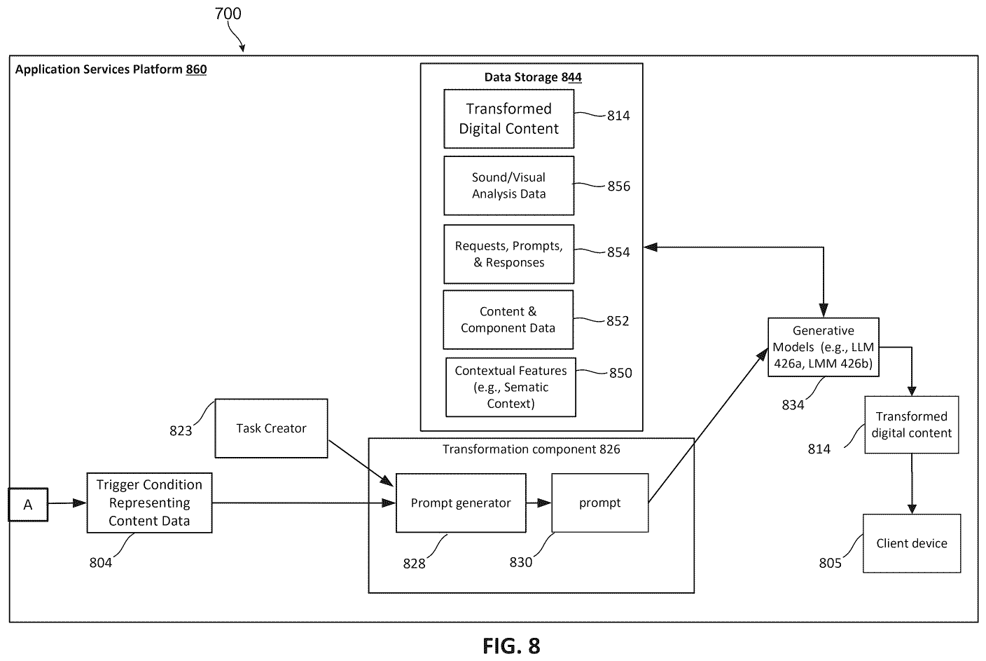

FIGS. 7 and 8 are dataflow diagrams of an asynchronous generative AI transformation of digital content in response to a trigger condition according to principles described herein. Specifically, FIG. 7 shows the upstream of the pipeline 700 for transforming a digital content.

The pipeline 700 can process various forms of digital content of interest, including text content 702a (e.g., text documents, URLs, and the like), images content 702b, audio content 702c, video content 702d, and structured file content 702e (e.g., emails, presentations, whiteboards, and the like). In another embodiment, the digital content of interest includes multiple types of digital content, such that the pipeline 700 divides the digital content of interest into one or more components such as the text content 702a, audio content 702c, images content 702b, audio content 702c, video content 702d, and structured file content 702e. The digital content of interest may contain one or more of these components, as well as other data types such as spreadsheet, chart, and the like. As depicted text content 702a may originate from text documents, URLs or other type of documents. Structured file content 702e may originate from emails, presentations, whiteboard or other type of structured document.

The pipeline 700 can use LLMs throughout the transformation pipeline 700. The transformation pipeline 700 involves interpreting these content forms into text when necessary, such as converting the image content 702b into descriptions, converting the audio content 702c into transcripts, dividing and converting the video content 702d into transcripts, timing data, image frames, and the like.

Continuing to FIG. 8, the interpreted data is assembled into a trigger condition representing content data 804 for processing. This means that the content data is examined to determine occurrence of a trigger condition which invokes a transformation action/performance of a task. The trigger condition representing content data 804 may include a portion of content data for which a transformation is needed. Once the trigger condition is detected, the trigger condition representing content data 804 is transmitted to the prompt generator 828 for generating a prompt 830 for transmission to the generative models 834. In addition to the trigger condition representing content data 804, the prompt generator may also receive data from the task creator 823. The task creator 823 is an element that generates a task which includes one or more trigger conditions and one or more actions that should be performed on the content upon detection of the trigger conditions. The task creator 823 transmits that actions to the prompt generator 828 so that the prompt generator 828 can generate the prompt based on the content data and the required action.

Pipeline 700 includes a transformation component 826 which includes the prompt generator 828 that generates the prompt 830 from the task and initiates a transformation process based on the prompt by transmitting the prompt 830 to the generative models 834. In one embodiment, in response to the prompt or a system call, either the task creator 823 or the generative models 834 retrieves content component data 702a-702e from the digital content of interest based on the prompt 830.

The generative models 834 performs the required action as indicated by the prompt 830 to generate the transformed digital content 814 which is then transmitted to the client device 805. In some examples, the generative model 834 generates the transformed digital content 814 in a predetermined format. The predetermined format may be predefined by the system or may be selected by the user. To achieve this, the prompt 830 may specify the type of format desired for the output. In some implementations, the pipeline 700 is designed to be iterative, allowing for refinement of the transformed digital content by revisiting and modifying the digital content generated by the generative models 834 until the transformed digital content 814 meets the expected standards and accurately represents of the intended information. In some implementations, the prompt generator 828 may submit further prompts to re-generate content(s) based on user feedback.

In addition to explicit grounding, in some implementations, the pipeline 700 applies implicit grounding to add additional contextual features (including semantic context) to the AI-model inputs. Implicit grounding refers to the ability of a generative AI model to understand and reference the real world without being explicitly programmed about it. This means the model learns the semantic context (e.g., people, places, events, other relevant attributes), styles, names, inner relationships, and the like of the digital content through its training data and interactions.

A data storage 844 can store contextual feature data 850, content and content component data 852, request, prompts and responses 854, sound/visual analysis data 856, and/or transformed digital content 814. The data storage 844 can be physical and/or virtual, depending on the system's needs and infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCI), network virtualization and software-defined networking (SDN), container storage, and the like.

Since the output creation involves use of a generative AI which utilizes user content such as digital content of a canvas, personal data privacy and data ownership guidelines are taken into consideration. There are security and privacy considerations and strategies for using open source generative models with enterprise data, such as data anonymization, isolating data, providing secure access, securing the model, using a secure environment, encryption, regular auditing, compliance with laws and regulations, data retention policies, performing privacy impact assessment, user education, performing regular updates, providing disaster recovery and backup, providing an incident response plan, third-party reviews, and the like. By following these security and privacy best practices, the pipeline 700 can minimize the risks associated with using generative models while protecting user data from unauthorized access or exposure.

In some implementations, the application services platform 860 runs the generative models 834 in a secure computing environment. Moreover, the application services platform 860 can employ robust network security, firewalls, and intrusion detection systems to protect against external threats. The application services platform 860 can encrypt the any data in transit. The application services platform 860 can also employ encryption standards for data storage and data transmission to safeguard against data breaches.

Moreover, the application services platform 860 can implement strong security measures around the generative models 834, such as regular security audits, code reviews, and ensuring that the model is up-to-date with security patches. The application services platform 860 can periodically audit the generative model's usage and access logs, to detect any unauthorized or anomalous activities. The application services platform 860 can also ensure that any use of open source generative models complies with relevant data protection regulations such as GDPR, HIPAA, or other industry-specific compliance standards.

The application services platform 860 can also establish data retention and data deletion policies to ensure that generated data is not stored longer than necessary, to minimizes the risk of data exposure. The application services platform 860 can perform a privacy impact assessment (PIA) to identify and mitigate potential privacy risks associated with the generative model's usage. The application services platform 860 can also provide mechanisms for training and educating users on the proper handling of data and the responsible use of generative models. In addition, the application services platform 860 can stay up-to-date with evolving security threats and best practices that are essential for ongoing data protection.

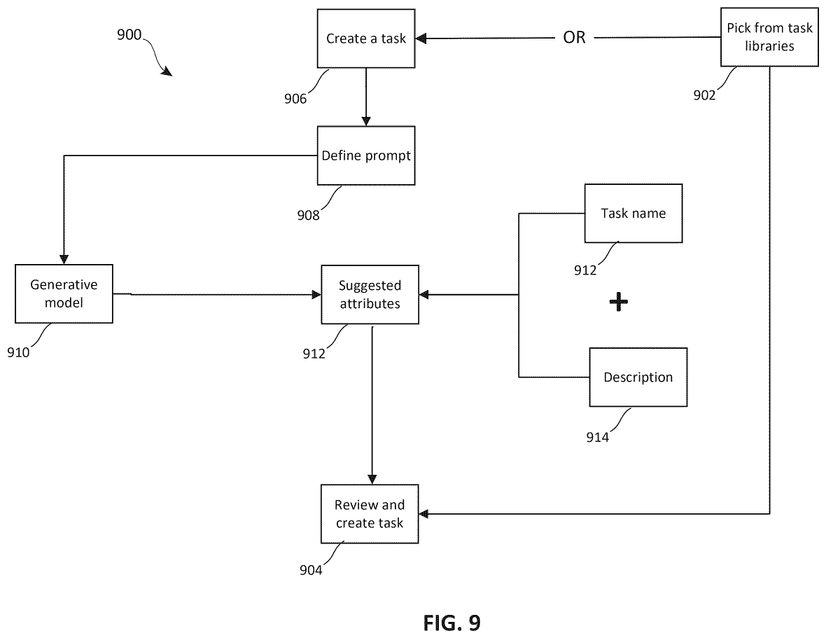

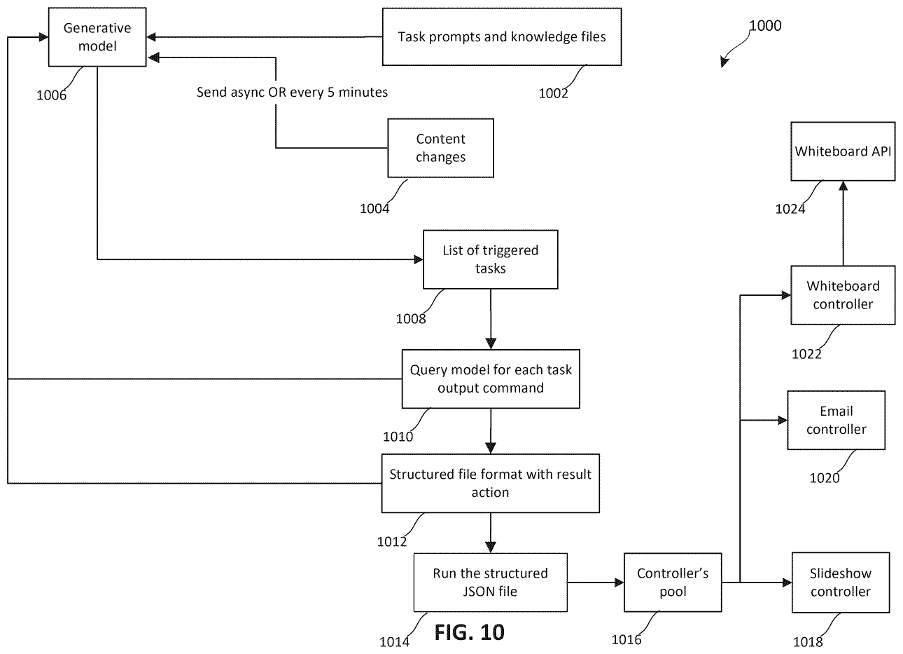

FIGS. 9 and 10 are data flow diagrams of an AI-based content generation application that implements the techniques described herein. The example data flow diagram shown in FIGS. 9 and 10 is implemented by an AI-based content generation application that utilizes a generative model such as an LLM. However, the techniques herein for providing are not limited to use in the AI-based content generation application and may be used to generate and transform digital content for other types of applications including but not limited to presentation applications, website authoring applications, collaboration platforms, communications platforms, and/or other types of applications in which users create, view, and/or modify various types of digital content.

FIG. 9 shows an example of a dataflow diagram of a workflow of a task creator of an asynchronous generative AI system of FIG. 1 according to principles described herein. The dataflow 900 operates in one of two alternatives. In the first alternative, a task is selected from a library of tasks (step 902). FIG. 4 illustrates example tasks in a library of tasks that can be selected in step 902. After a task is selected (step 902), then the attributes of the task can be reviewed, and the task can be assigned to the content (step 904).

In the second alternative of dataflow 900, instead of selecting a task, a task is created (step 906). Creating the task involves defining a prompt (e.g. entering a natural language text for the task) (step 908). The prompt includes the trigger condition as well as the function that should be performed when the trigger condition occurs. FIG. 4 illustrates a new task 420 that can be created or added. FIG. 5 shows an example of the user interface 515 of a task creator of an AI-based content generation application in which the user can create a task for interacting with an AI generative model to transform content in response to a trigger condition.

In some embodiments, the natural language prompt is submitted to a generative model (step 910) for processing. The generative model analyzes the prompt to identify the trigger conditions and/or the function that should be performed based on the trigger condition to generate suggested attributes (step 912). The suggested attributes may include or can be aggregated with a task name or icon 914 and/or a description 916. A new task is then generated based on the suggested attributes (step 904).

FIG. 10 shows an example of a dataflow diagram of asynchronous generative AI transformation of digital content in response to a trigger condition according to principles described herein.

The workflow 1000 begins with sending task prompts (and optionally knowledge files) 1002 and monitored application content changes 1004 (such as monitored whiteboard changes) to the generative AI model 1006 (e.g., an LLM). The generative AI model examines the task prompts, knowledge files and monitored content changes to generate a list of triggered tasks 1008. The list of triggered tasks 1008 are identified based on trigger conditions detected in the monitored content changes and based on the prompt and/or knowledge files which indicate which functions should be performed upon detection of a trigger condition. The generative AI model is then queried at 1010, for each of the tasks in the list of triggered tasks 1008. In response to receiving the list of triggered tasks as an input, the generative AI model generates a structured file 1012 that describes one or more actions that should be performed based on the triggered tasks. In some implementations, the structured file is a JSON file. The structured file may be generated based on the type of output desired for the triggered task. Thereafter, the structured file is executed at 1014. This may be achieved by utilizing a controller's pool 1016 which directs the execution of the file 1012 to any one of a number of application controllers. The type of controller used varies depending on the type of application and may include a slideshow controller 1018 (for a presentation application), an email controller 1020 (for an email application) or a whiteboard controller 1022 (for a whiteboard application). In an example, the controller such as the whiteboard controller 1022 utilizes an API such as the whiteboard API 1024 to execute the action. As a result, the instructions within the structured file 1012 are converted to an appropriate output depending on the type of application for which the task is being formatted and depending on the type of format selected.

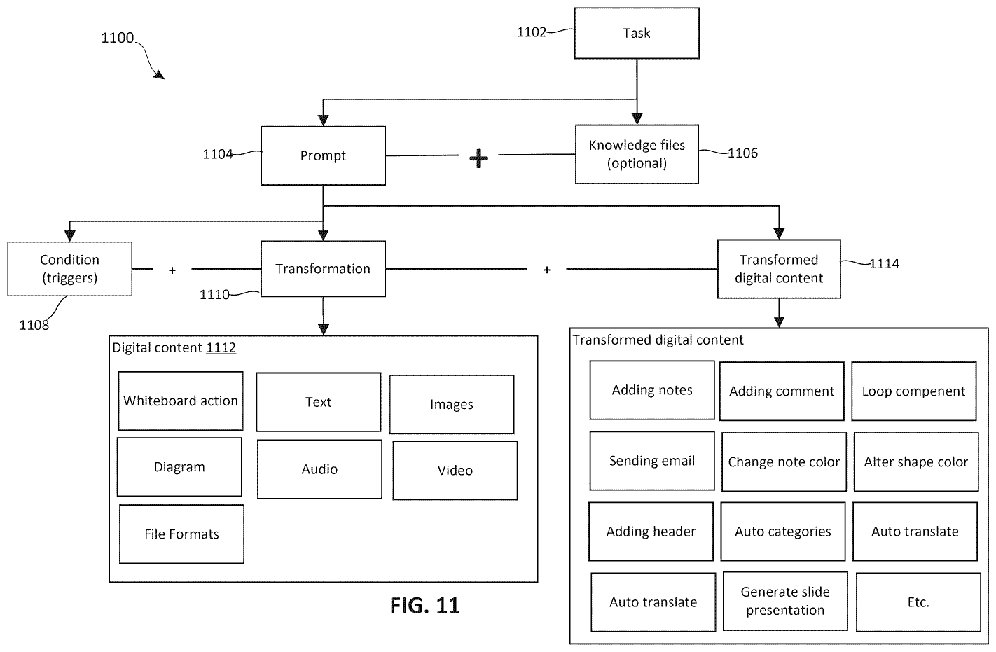

FIG. 11 shows an example of a task data flow diagram of an asynchronous generative AI transformation system that operates in response to a trigger condition, according to principles described herein.

In the flow diagram 1100, a task 1102 is first created, as such by the task creator 126 in FIG. 1 or the task creator 823 in FIG. 8. The purpose of the task 1102 is to create and/or transform digital content that is managed by a content generation application, such as a notes application, an email application, a slide presentation application or a collaboration platform, based on the function and the trigger in the task. Each task 1102 includes both a function to be performed in the digital content and a trigger for performing the function.

A prompt 1104 is then generated which includes a function that is performed when a condition trigger 1108 is satisfied, upon which a transformation process 1110 is performed, resulting in transformed digital content 1114. The prompt 1104 is generated based on the function in the task, as described in FIG. 1 and FIG. 8. In some embodiments, the prompt 1104 is generated further based on knowledge file(s) 1106.

The transformation process 1110 is performed, based on a prompt. As part of the transformation process 1110, the prompt 1104 and digital content 1112 are provided as an input to one or more generative models, such as the generative models 134 in FIG. 1. The transformation process 1110 yields a transformed digital content 1114 from the digital content 1112. Thus, for different types of digital content such as the types displayed in the digital content 1112, different functions can be performed to generate the transformed digital content 1114. For example, when the digital content includes a whiteboard action, the function may be adding notes to the whiteboard canvas.

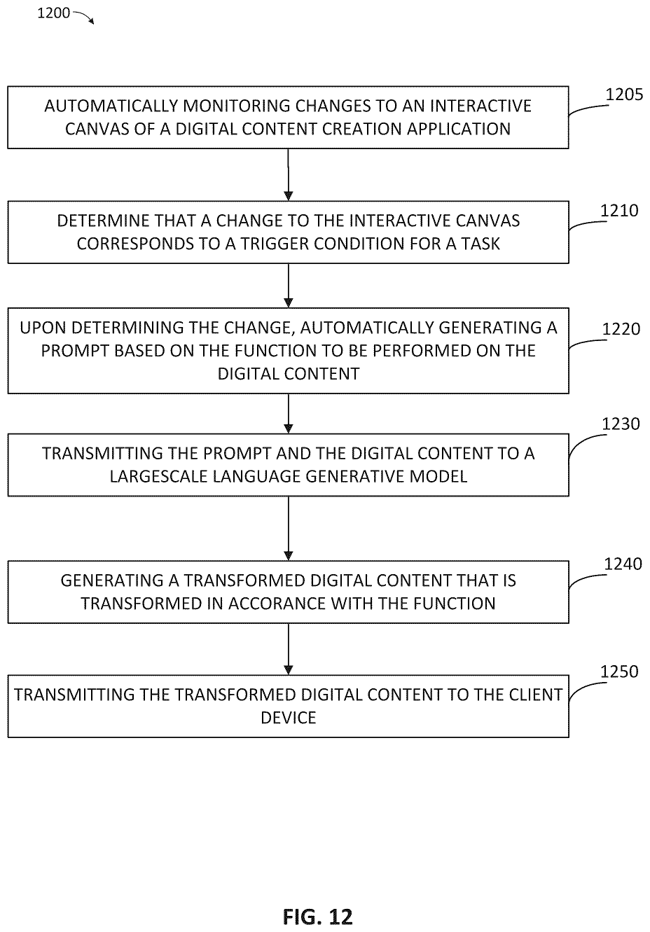

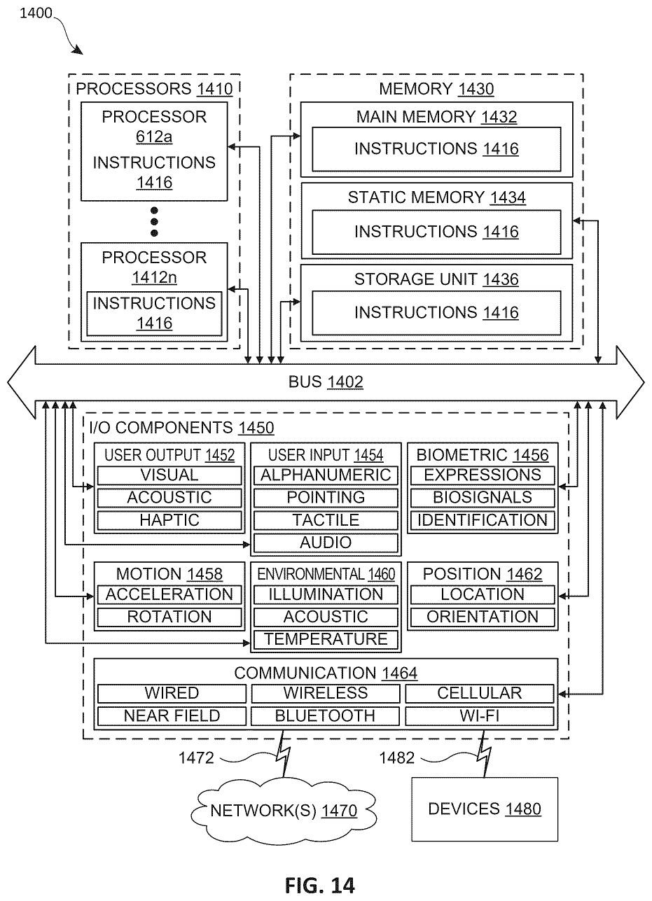

FIG. 12 is a flow chart of an example process for asynchronous generative AI transformation of digital content in response to a trigger condition according to the techniques disclosed herein. The process 1200 can be implemented by the application services platform 110 or its components shown in the preceding examples. The process 1200 may be implemented in, for instance, the example a machine including a processor and a memory as shown in FIG. 14. As such, the application services platform 110 can provide means for accomplishing various parts of the process 1200, as well as means for accomplishing embodiments of other processes described herein in conjunction with other components of the example computing environment 100. Although the process 1200 is illustrated and described as a sequence of steps, it is contemplated that various embodiments of the process 1200 may be performed in any order or combination and need not include all the illustrated steps.

In one embodiment, for example, in step 1205, changes to an interactive canvas of a digital content creation application being executed on a client device are automatically monitored. This may be achieved by periodically sending a signal to a generative AI tool to identify the changes that have occurred on the canvas since the last signal. Upon receipt of the monitored changes, in step 1210, a generative AI model (e.g., the generative models 134) determines that a change to the interactive canvas corresponds to a trigger condition for an existing task, the task including the trigger condition and a function to be performed on a digital content appearing in the digital content creation application upon occurrence of the trigger condition. The digital content may include any of text, audio, video, or structured file.

In step 1220, upon determining that the change corresponds to the trigger condition, a prompt is automatically generated, via a prompt generator, based on the function to be performed on the digital content. The prompt is generated for transmission for a generative AI model and is based on the function that should modify the digital content. For example, where the digital content is text content, the task is “detect and expand any acronym” in the text content, then the transformation could be the generation of the full wording of the acronym in the text content.

In step 1230, the prompt and the digital content are transmitted to a largescale language generative model. In some implementations, the prompt includes the digital content and a knowledge file to enable the generative model to accurately transform the digital content. In step 1240, a transformed digital content that is modified in accordance with the function is generated via the generative AI model. The transformation is performed by transmitting the prompt that is generated in step 1220 to the generative model, yielding a transformed digital content. In one embodiment, the generative model is a multimodal. For example, where the digital content is text content and the task is “detect and expand any acronym” in the text content, the transformation could be the generation of the full wording of the acronym in the text content, and the task is triggered by detection of an acronym such as “a.p.i” in the text content. The model will generate the phrase “application program interface” as a transformed digital content, and the phrase will be available to replace “a.p.i”in the text content.

In step 1250, the transformed digital content is transmitted to the client device to be displayed on a user interface (e.g., the user interface 200 in FIG. 2) of the client device. For example, the transformed digital content is inserted as text on a diagram of a virtual whiteboard application.

The detailed examples of systems, devices, and techniques described in connection with FIG. 1, FIG. 2, FIG. 6, FIG. 7, FIG. 8, FIG. 9, FIG. 10, FIG. 11 AND FIG. 12 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIG. 1, FIG. 2, FIG. 6, FIG. 7, FIG. 8, FIG. 9, FIG. 10, FIG. 11 AND FIG. 12 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

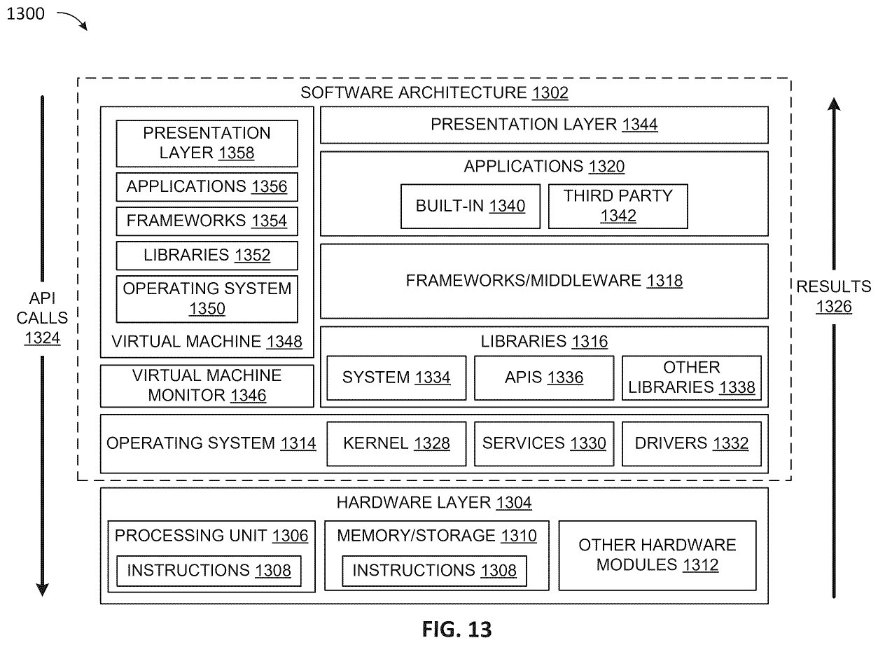

FIG. 13 is a block diagram 1300 illustrating an example software architecture 1302, various portions of which may be used in conjunction with various hardware architectures herein described, which may implement any of the above-described features. FIG. 13 is a non-limiting example of a software architecture, and it will be appreciated that many other architectures may be implemented to facilitate the functionality described herein. The software architecture 1302 may execute on hardware such as a machine 1400 of FIG. 14 that includes, among other things, processors 1410, memory 1430, and input/output (I/O) components 1450. A representative hardware layer 1304 is illustrated and can represent, for example, the machine 1400 of FIG. 14. The representative hardware layer 1304 includes a processing unit 1306 and associated executable instructions 1308. The executable instructions 1308 represent executable instructions of the software architecture 1302, including implementation of the methods, modules and so forth described herein. The hardware layer 1304 also includes a memory/storage 1310, which also includes the executable instructions 1308 and accompanying data. The hardware layer 1304 may also include other hardware modules 1312. Instructions 1308 held by processing unit 1306 may be portions of instructions 1308 held by the memory/storage 1310.

The example software architecture 1302 may be conceptualized as layers, each providing various functionality. For example, the software architecture 1302 may include layers and components such as an operating system (OS) 1314, libraries 1316, frameworks 1318, applications 1320, and a presentation layer 1344. Operationally, the applications 1320 and/or other components within the layers may invoke API calls 1324 to other layers and receive corresponding results 1326. The layers illustrated are representative in nature and other software architectures may include additional or different layers. For example, some mobile or special purpose operating systems may not provide the frameworks/middleware 1318.

The OS 1314 may manage hardware resources and provide common services. The OS 1314 may include, for example, a kernel 1328, services 1330, and drivers 1332. The kernel 1328 may act as an abstraction layer between the hardware layer 1304 and other software layers. For example, the kernel 1328 may be responsible for memory management, processor management (for example, scheduling), component management, networking, security settings, and so on. The services 1330 may provide other common services for the other software layers. The drivers 1332 may be responsible for controlling or interfacing with the underlying hardware layer 1304. For instance, the drivers 1332 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 1316 may provide a common infrastructure that may be used by the applications 1320 and/or other components and/or layers. The libraries 1316 typically provide functionality for use by other software modules to perform tasks, rather than interacting directly with the OS 1314. The libraries 1316 may include system libraries 1334 (for example, C standard library) that may provide functions such as memory allocation, string manipulation, file operations. In addition, the libraries 1316 may include API libraries 1336 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 1316 may also include a wide variety of other libraries 1338 to provide many functions for applications 1320 and other software modules.

The frameworks 1318 (also sometimes referred to as middleware) provide a higher-level common infrastructure that may be used by the applications 1320 and/or other software modules. For example, the frameworks 1318 may provide various graphic user interface (GUI) functions, high-level resource management, or high-level location services. The frameworks 1318 may provide a broad spectrum of other APIs for applications 1320 and/or other software modules.

The applications 1320 include built-in applications 1340 and/or third-party applications 1342. Examples of built-in applications 1340 may include, but are not limited to, a contacts application, a browser application, a location application, a media application, a messaging application, and/or a game application. Third-party applications 1342 may include any applications developed by an entity other than the vendor of the particular platform. The applications 1320 may use functions available via OS 1314, libraries 1316, frameworks 1318, and presentation layer 1344 to create user interfaces to interact with users.

Some software architectures use virtual machines, as illustrated by a virtual machine 1348. The virtual machine 1348 provides an execution environment where applications/modules can execute as if they were executing on a hardware machine (such as the machine 1400 of FIG. 14, for example). The virtual machine 1348 may be hosted by a host OS (for example, OS 1314) or hypervisor, and may have a virtual machine monitor 1346 which manages operation of the virtual machine 1348 and interoperation with the host operating system. A software architecture, which may be different from software architecture 1302 outside of the virtual machine, executes within the virtual machine 1348 such as an OS 1350, libraries 1352, frameworks 1354, applications 1356, and/or a presentation layer 1358.

FIG. 14 is a block diagram illustrating components of an example machine 1400 configured to read instructions from a machine-readable medium (for example, a machine-readable storage medium) and perform any of the features described herein. The example machine 1400 is in a form of a computer system, within which instructions 1416 (for example, in the form of software components) for causing the machine 1400 to perform any of the features described herein may be executed. As such, the instructions 1416 may be used to implement modules or components described herein. The instructions 1416 cause unprogrammed and/or unconfigured machine 1400 to operate as a particular machine configured to carry out the described features. The machine 1400 may be configured to operate as a standalone device or may be coupled (for example, networked) to other machines. In a networked deployment, the machine 1400 may operate in the capacity of a server machine or a client machine in a server-client network environment, or as a node in a peer-to-peer or distributed network environment. Machine 1400 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 1400 is illustrated, the term “machine” includes a collection of machines that individually or jointly execute the instructions 1416.

The machine 1400 may include processors 1410, memory 1430, and I/O components 1450, which may be communicatively coupled via, for example, a bus 1402. The bus 1402 may include multiple buses coupling various elements of machine 1400 via various bus technologies and protocols. In an example, the processors 1410 (including, for example, a central processing unit (CPU), a graphics processing unit (GPU), a neural processing unit (NPU), a digital signal processor (DSP), an ASIC, or a suitable combination thereof) may include one or more processors 1412a to 1112n that may execute the instructions 1416 and process data. In some examples, one or more processors 1410 may execute instructions provided or identified by one or more other processors 1410. The term “processor” includes a multi-core processor including cores that may execute instructions contemporaneously. Although FIG. 14 shows multiple processors, the machine 1400 may include a single processor with a single core, a single processor with multiple cores (for example, a multi-core processor), multiple processors each with a single core, multiple processors each with multiple cores, or any combination thereof. In some examples, the machine 1400 may include multiple processors distributed among multiple machines.

The memory/storage 1430 may include a main memory 1432, a static memory 1434, or other memory, and a storage unit 1436, both accessible to the processors 1410 such as via the bus 1402. The storage unit 1436 and memory 1432, 1434 store instructions 1416 embodying any one or more of the functions described herein. The memory/storage 1430 may also store temporary, intermediate, and/or long-term data for processors 1410. The instructions 1416 may also reside, completely or partially, within the memory 1432, 1434, within the storage unit 1436, within at least one of the processors 1410 (for example, within a command buffer or cache memory), within memory at least one of I/O components 1450, or any suitable combination thereof, during execution thereof. Accordingly, the memory 1432, 1434, the storage unit 1436, memory in processors 1410, and memory in I/O components 1450 are examples of machine-readable media.

As used herein, “machine-readable medium” refers to a device able to temporarily or permanently store instructions and data that cause machine 1400 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 1416) for execution by a machine 1400 such that the instructions, when executed by one or more processors 1410 of the machine 1400, cause the machine 1400 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 1450 may include a wide variety of hardware components adapted to receive input, provide output, produce output, transmit information, exchange information, capture measurements, and so on. The specific I/O components 1450 included in a particular machine will depend on the type and/or function of the machine. For example, mobile devices such as mobile phones may include a touch input device, whereas a headless server or IoT device may not include such a touch input device. The particular examples of I/O components illustrated in FIG. 14 are in no way limiting, and other types of components may be included in machine 1400. The grouping of I/O components 1450 are merely for simplifying this discussion, and the grouping is in no way limiting. In various examples, the I/O components 1450 may include user output components 1452 and user input components 1454. User output components 1452 may include, for example, display components for displaying information (for example, a liquid crystal display (LCD) or a projector), acoustic components (for example, speakers), haptic components (for example, a vibratory motor or force-feedback device), and/or other signal generators. User input components 1454 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 1450 may include biometric components 1456, motion components 1458, environmental components 1460, and/or position components 1462, among a wide array of other physical sensor components. The biometric components 1456 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 1458 may include, for example, acceleration sensors (for example, an accelerometer) and rotation sensors (for example, a gyroscope). The environmental components 1460 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 1462 may include, for example, location sensors (for example, a Global Position System (GPS) receiver), altitude sensors (for example, an air pressure sensor from which altitude may be derived), and/or orientation sensors (for example, magnetometers).

The I/O components 1450 may include communication components 1464, implementing a wide variety of technologies operable to couple the machine 1400 to network(s) 1470 and/or device(s) 1480 via respective communicative couplings 1472 and 1482. The communication components 1464 may include one or more network interface components or other suitable devices to interface with the network(s) 1470. The communication components 1464 may include, for example, components adapted to provide wired communication, wireless communication, cellular communication, Near Field Communication (NFC), Bluetooth communication, Wi-Fi, and/or communication via other modalities. The device(s) 1480 may include other machines or various peripheral devices (for example, coupled via USB).

In some examples, the communication components 1464 may detect identifiers or include components adapted to detect identifiers. For example, the communication components 1464 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 1464, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor; and
a memory storing executable instructions that, when executed, cause the processor alone or in combination with other processors to perform operations of:
automatically monitoring changes to an interactive canvas of a digital content creation application being executed on a client device;
determine, based on the monitored changes, that a change to the interactive canvas corresponds to a trigger condition for a task, the task including the trigger condition and a function to be performed on a digital content appearing in the digital content creation application, wherein the digital content includes any of text, audio, video, or structured file;
upon determining that the change corresponds to the trigger condition, automatically generating a prompt, via a prompt generator, based on the function to be performed on the digital content;
transmitting the prompt and the digital content as an input to a largescale language generative model,
generating, via the largescale language generative model, a transformed digital content that is modified in accordance with the function; and
transmitting the transformed digital content to the client device to be presented on a user interface of the client device.

2. The data processing system of claim 1, wherein the task is created from data entered into a user interface display of the client device.

3. The data processing system of claim 1, wherein the task is selected from a library of pre-defined tasks.

4. The data processing system of claim 1, wherein the transmitting the prompt and the digital content to the largescale language generative model, further comprises:
transmitting the prompt, a knowledge file and the digital content to a largescale language generative model.

5. The data processing system of claim 1, wherein in response to transmitting the prompt and the digital content, transformation of the digital content is initiated based on the prompt and a knowledge file.

6. The data processing system of claim 1, wherein the digital content further comprises text digital content and the trigger condition further comprises:
any acronym in the text digital content.

7. The data processing system of claim 1, wherein the digital content further comprises text digital content and the trigger condition further comprises:
any reference in the text digital content.

8. A method comprising:
automatically monitoring changes to an interactive canvas of a digital content creation application being executed on a client device;
determine, based on the monitored changes, that a change to the interactive canvas corresponds to a trigger condition for a task, the task including a trigger condition and a function to be performed on a digital content appearing in the digital content creation application, wherein the digital content includes any of text, audio, video, or structured file;
upon determining that the change corresponds to the trigger condition, automatically generating a prompt, via a prompt generator, based on the function to be performed on the digital content;
transmitting the prompt and the digital content as an input to a largescale language generative model;
generating, via the largescale language generative model, a transformed digital content that is modified in accordance with the function; and
transmitting the transformed digital content to the client device to be presented on a user interface of the client device.

9. The method of claim 8, wherein creating the task further comprises:
creating the task from data entered into a user interface display of the client device.

10. The method of claim 8, wherein creating the task further comprises a format for the transformed digital content.

11. The method of claim 8, wherein the digital content creation application further comprises a digital whiteboard application.

12. The method of claim 8, wherein the digital content creation application further comprises a virtual meeting and collaboration application.

13. The method of claim 8, wherein the digital content further comprises text digital content and the trigger condition further comprises:
any acronym in the text digital content.

14. The method of claim 8, wherein the trigger condition further comprises:
the trigger condition being representative of digital content to an event to asynchronously generate or define the prompt.

15. A non-transitory computer readable medium on which are stored instructions that, when executed, cause a programmable device to perform processes of:
creating a task including a trigger condition and a function to be performed on a digital content appearing in a digital content creation application, wherein the digital content includes any of text, audio, video, or structured file;
asynchronously monitoring to identify an existence of the trigger condition in the digital content on a client device;
upon identifying the existence of the trigger condition in the digital content on the client device, automatically generating a prompt based on the function to be performed on the digital content;
transforming the digital content by transmitting the prompt, a knowledge file and the digital content to a largescale language generative model, yielding a transformed digital content that is modified in accordance with the function; and
transmitting the transformed digital content to the client device to be presented on a user interface of the client device.

16. The non-transitory computer readable medium of claim 15, wherein the stored instructions further include stored instructions that, when executed, cause the programmable device to create the task based on a user request provided in natural language.

17. The non-transitory computer readable medium of claim 15, wherein the stored instructions further include stored instructions, when executed, cause the programmable device to perform the processes, that further comprise performing the processes via an application services platform.

18. The non-transitory computer readable medium of claim 15, wherein the stored instructions further include stored instructions that, when executed, cause the programmable device to perform the processes of creating the task, automatically generating the prompt and transforming the digital content, that further comprise performing the processes via an application services platform.

19. The non-transitory computer readable medium of claim 15, wherein the digital content creation application further comprises a note-taking application.

20. The non-transitory computer readable medium of claim 15, wherein transmitting the transformed digital content to the client device further comprises utilizing a controller for the digital content application to convert the transformed digital content to an appropriate type of output for the digital content application.
